(19) United States
(12) Patent Application Publication
(10) Pub. No.: US 2014/0208959 A1
(43) Pub. Date: Jul. 31, 2014

(54) WATERFLOW DISTRIBUTION VARIABLE FRYER

(71) Applicant: Ishiyo Production Co., Ltd., Tokyo (JP)

(72) Inventors: Tsunehito WAKII, Tokyo (JP); Chikako ISHIZUKA, Tokyo (JP); Ayumi KIKUCHI, Tokyo (JP)

(73) Assignee: Ishiyo Production Co., Ltd., Tokyo (JP)

(21) Appl. No.: 14/168,199

(22) Filed: Jan. 30, 2014

(30) Foreign Application Priority Data
Jan. 30, 2013 (JP) 2013-014992
Jul. 16, 2013 (JP) 2013-148080

(51) Int. Cl. A47J 37/12

(52) U.S. Cl. CPC A47J 37/1285
USPC 99/408

(57) ABSTRACT

Water jetted from holes of a rotating pipe strikes against the inclined surfaces of blade plates to be radially jetted from a water supplier. The water radially jetted from the water supplier produces water jet flows (jet flows) under an intermediate layer. The striking of the water jetted from the holes against the inclined surfaces of the blade plates causes the rotation of a circular plate, the blade plates, and the rotating pipe. The directions of the water jet flows change in accordance with the rotation of the circular plate, the blade plates, and the rotating pipe.

### CROSS-REFERENCE TO RELATED APPLICATION

This application claims the benefit of Japanese Patent Application No. 2013-014992, filed on Jan. 30, 2013 and Japanese Patent Application No. 2013-148080 filed on Jul. 16, 2013, the entire disclosures of which are incorporated by reference herein.

### FIELD

The present invention relates to a variable waterflow-distribution fryer.

### BACKGROUND

There is a fryer provided with a tank and a heater arranged in the tank. When water is supplied into the tank, a water layer is formed. Additionally, when oil is supplied into the tank, an oil layer is formed on the water layer. Bread crumbs used for frying contain an emulsifier (a surfactant) such as a glycerol fatty acid ester preparation derived from soybeans. The emulsifier forms an intermediate layer containing an emulsion substance between the oil layer and the water layer. Fried scum bits sink in the oil layer but stagnate in the intermediate layer without sinking into the water layer. The fried scum bits stagnating in the intermediate layer become a factor that deteriorates the oil.

Unexamined Japanese Patent Application Kokai Publication No. 2012-183273 discloses a fryer in which water having such a predetermined flow rate as to cause no swirling flow in the oil layer is jetted into a water layer horizontally from the inner wall of a tank. The fryer breaks a part of an intermediate layer near a wall surface of the tank positioned in a direction in which the water is jetted and produces a flow of water that travels toward a water discharge outlet from the vicinity of the inner wall of the tank, thereby promoting the sinking of fried scum bits. However, since the broken part of the intermediate layer is narrow, the fryer cannot efficiently promote the sinking of fried scum bits.

Unexamined Japanese Patent Application Kokai Publication No. 2010-172677 discloses a fryer in which water having a predetermined flow rate is jetted into a water layer from nozzles oriented in obliquely downward directions and nozzles oriented in obliquely horizontal directions from the inner wall of a tank and the predetermined flow rate of water is discharged from a water discharge outlet of a lower part of the tank. The fryer produces a spiral swirling flow traveling downward in the water layer and causes the swirling flow to rotate rotary wings arranged on the lower part of the tank, so that fried scum bits are dropped down into a scum reservoir. However, the fryer does not cause the sinking of fried scum bits stagnating in the intermediate layer. Therefore, the present invention provides a variable waterflow-distribution fryer that can efficiently cause the sinking of fried scum bits stagnating in an intermediate layer.

### SUMMARY

A first aspect of a variable waterflow-distribution fryer according to the present invention is a variable waterflow-distribution fryer comprising:

a tank accommodating oil and water, in which a specific gravity difference between the oil and the water causes formation of an oil layer on top and a water layer on bottom;

a heater arranged in the oil layer;

a water supplier supplying water into the water layer; and

a water discharger discharging the water of the water layer from a lower part of the tank,

wherein in the water layer under an intermediate layer formed between the oil layer and the water layer, the water supplier substantially horizontally jets water and changes the direction of the jetting of the water.

A second aspect of the variable waterflow-distribution fryer according to the present invention is the variable waterflow-distribution fryer of the first aspect, wherein in the water layer, the water supplier jets water radially from a cross-sectional center portion of the tank and rotates a jet flow around the center portion of the tank.

A third aspect of the variable waterflow-distribution fryer of the present invention is the variable waterflow-distribution fryer of the second aspect, wherein the water supplier comprises:

a water pipe fixed to the tank to guide water from outside of the tank to inside of the tank and guide the water upward in a longitudinal-sectional center portion of the tank and the water layer; and

a rotary body including a circular plate, a plurality of blade plates radially fixed to one end surface of the circular plate from a center portion of the plate to a peripheral portion of the plate, a vertically extending rotating pipe fixed to the center portion of the circular plate, and holes provided on a peripheral surface of the rotating pipe, each of the holes facing each of the plurality of blade plates, in which the rotating pipe is fitted onto an upper portion of the water pipe, and water jetted through the holes of the rotating pipe from a plurality of holes of the water pipe is caused to strike against the plurality of blade plates to rotate the circular plate with respect to the water pipe,

the water supplier substantially horizontally jetting the water having struck against the plurality of blade plates.

A fourth aspect of the variable waterflow-distribution fryer of the present invention is the variable waterflow-distribution fryer of the second aspect, wherein the water supplier comprises:

a water pipe fixed to the tank to guide water from outside of the tank to inside of the tank and guide the water upward in a longitudinal-sectional center portion of the tank and the water layer;

a branching jet pipe connected to the water pipe to branch the water guided by the water pipe into a plurality of water flows and jet the water flows toward right above the jet pipe from an upper end surface of the jet pipe; and

a rotary body including a circular plate, a plurality of blade plates radially fixed to one end surface of the circular plate from a center portion of the plate to a peripheral portion of the plate, and a spindle supporting the circular plate that is horizontally arranged, rotatably around the center of the plate, a lower-end portion of the spindle that is vertically arranged being fixed onto a center portion of the upper end surface of the branching jet pipe, and wherein the water jetted from the branching jet pipe is caused to strike against the plurality of blade plates and reflected substantially horizontally to rotate the circular plate.

A fifth aspect of the variable waterflow-distribution fryer according to the present invention is the variable waterflow-distribution fryer of the first aspect, wherein the water supplier intermittently jets water having a flow rate that allows a fried scum bit stagnating in the intermediate layer to move horizontally, from a wall surface of the tank into the water layer.

A sixth aspect of the variable waterflow-distribution fryer according to the present invention is the variable waterflow-distribution fryer of the fifth aspect, wherein the water supplier cyclically repeats an operation of starting a jetting of water into the water layer from a plurality of portions of the wall surface of the tank in a predetermined order and stopping the jetting of the water in the predetermined order.

A seventh aspect of the variable waterflow-distribution fryer according to the present invention is the variable waterflow-distribution fryer of the first aspect, wherein the water discharger comprises a water discharge pipe connected to the tank and a water discharge accelerator accelerating water in the water discharge pipe in a direction of flow of the water.

An eighth aspect of the variable waterflow-distribution fryer according to the present invention is the variable waterflow-distribution fryer of the seventh aspect, wherein the water discharge accelerator comprises a water jet nozzle that jets water in the flow direction in order to accelerate the water flowing through the water discharge pipe.

A ninth aspect of the variable waterflow-distribution fryer according to the present invention is the variable waterflow-distribution fryer of the eighth aspect, wherein the water discharge pipe comprises a curved portion that changes the direction of the flow of the water in the water discharge pipe, and the water jet nozzle is provided at the curved portion.

A tenth aspect of the variable waterflow-distribution fryer according to the present invention is the variable waterflow-distribution fryer of the eighth aspect, wherein the water jet nozzle penetrates through the water discharge pipe and is provided in such a manner that a tip surface of the nozzle is made flush with an inner surface of the water discharge pipe.

According to the first aspect or the second aspect, in the water layer under the intermediate layer, the water supplier substantially horizontally jets water and changes the direction of the jetting of the water. The intermediate layer is subjected to a downward force and the distribution of magnitude of the force changes over time. Thus, the intermediate layer oscillates vertically, thereby allowing efficient sinking of the fried scum bits from the intermediate layer.

According to the third or fourth aspect, the water supplier radially jets water from the cross-sectional center portion of the tank and rotates jet flows around the center portion in the water layer. Thus, the intermediate layer oscillates vertically, thereby allowing efficient sinking of the fried scum bits from the intermediate layer.

According to the fifth embodiment, the water supplier intermittently jets water with a flow rate that allows the fried scum bit stagnating in the intermediate layer to move horizontally, from the wall surface of the tank into the water layer. Thus, the intermediate layer oscillates vertically without rotating the water supplier itself, thereby allowing efficient sinking of the fried scum bits from the intermediate layer.

According to the sixth aspect, the water supplier cyclically repeats the operation of starting a jetting of the water into the water layer from a plurality of portions on the wall surface of the tank in a predetermined order and stopping the jetting of the water in the predetermined order. Thus, the intermediate layer oscillates vertically, thereby allowing efficient sinking of the fried scum bits from the intermediate layer.

According to the seventh aspect, the water in the water discharge pipe is accelerated in the direction in which the water flows, so that the flow rate of water supplied into the water layer can be set to be large. Thus, the entire part of the intermediate layer formed in the tank oscillates vertically, thereby allowing efficient sinking of the fried scum bits from the intermediate layer.

According to the structure of the eighth aspect, the water discharge accelerator comprises a water jet nozzle. Accordingly, the water flowing through the water discharge pipe can be accelerated by the simple structure.

According to the structure of the ninth aspect, the water jet nozzle is provided at the curved portion changing the flow of water in the water discharge pipe. Thus, water can be efficiently accelerated at the curved portion.

According to the structure of the tenth aspect, the tip portion of the water jet nozzle does not interfere with the fried scum bit flowing through the water discharge pipe. Thus, the structure can prevent the reduction of the flow rate of water in the water discharge pipe due to clogging of the fried scum bits.

### BRIEF DESCRIPTION OF THE DRAWINGS

A more complete understanding of this application can be obtained when the following detailed description is considered in conjunction with the following drawings, in which:

FIG. 1 is a schematic longitudinal sectional view of a variable waterflow-distribution fryer according to a first embodiment of the present invention;

FIG. 2A is a schematic bottom view of a water supplier;

FIG. 2B is a schematic front view of the water supplier;

FIG. 2C is an illustrative view of a rotation operation of the water supplier;

FIG. 3 is an illustrative view of a jet flow operation by the water supplier in a water layer;

FIG. 4A is an illustrative view of a principle that causes the sinking of a fried scum bit;

FIG. 4B is an illustrative view of the principle that causes the sinking of the fried scum bit;

FIG. 5 is an illustrative view of a water flow on an upper portion of a rotary plate of the water supplier;

FIG. 6 is a schematic front view of a water supplier of a variable waterflow-distribution fryer according to a second embodiment of the present invention;

FIG. 7 is a schematic exploded perspective view of a water supplier of a variable waterflow-distribution fryer according to a third embodiment of the present invention;

FIG. 8 is a schematic front view of an assembly of the water supplier of FIG. 7;

FIG. 9 is a bottom view for illustrating an operation of the water supplier of FIG. 8;

FIG. 10A is a schematic illustrative view of a water supplier of a variable waterflow-distribution fryer according to a fourth embodiment of the present invention;

FIG. 10B is a schematic illustrative view of the water supplier of the variable waterflow-distribution fryer according to the fourth embodiment of the present invention;

FIG. 11 is a schematic longitudinal sectional view of a variable waterflow-distribution fryer according to a fifth embodiment of the present invention;

FIG. 12 is a partial sectional view of a water discharger of FIG. 11;

FIG. 13 is an illustrative view of a state in which water flows through a water discharge pipe;

FIG. 14A is view showing a modification of the water discharger;

FIG. 14B is a view showing a modification of the water discharger;

FIG. 14C is a view showing a modification of the water discharger;

FIG. 15A is a view showing a modification of the water discharger; and

FIG. 15B is a view showing a modification of the water discharger.

### DETAILED DESCRIPTION

### First Embodiment

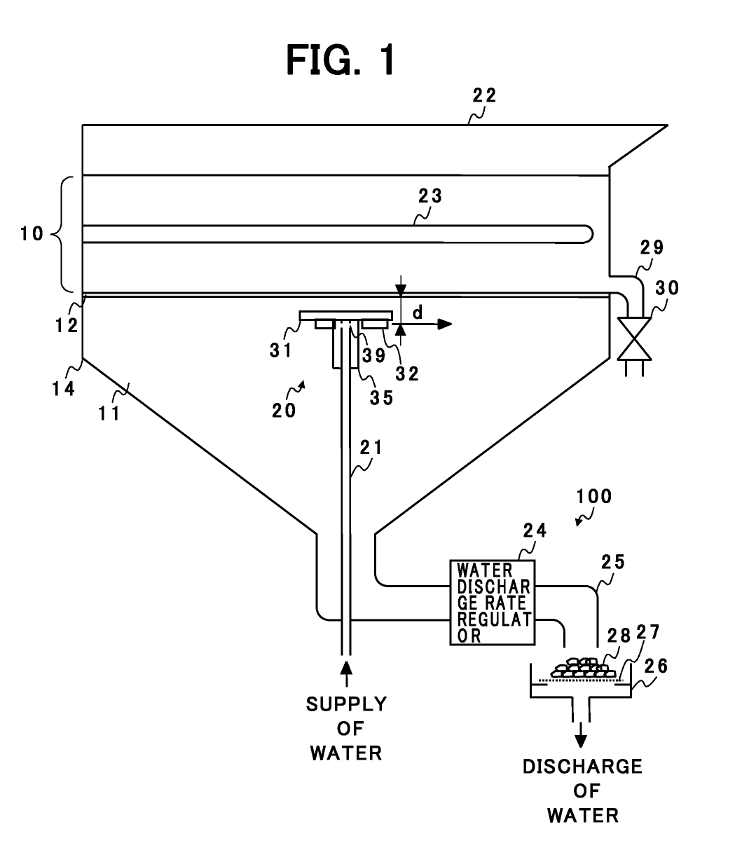

FIG. 1 is a schematic longitudinal sectional view of a variable waterflow-distribution fryer according to a first embodiment of the present invention.

A tank 14 has a rectangular cross-section. The tank 14 includes an upper part having a hollow quadrangular prism shape and a lower part having a hollow, substantially reversed quadrangular pyramid shape. In the tank 14 are formed an oil layer 10 and a water layer 11, as will be described below. A water pipe 21 of a water supplier 20 is fixed to a lower-end center of the tank 14. The water pipe 21 extends vertically to pass through the center of the tank 14. Details of the structure of the water supplier 20 will be described later.

In the oil layer 10, a heater 23 is horizontally provided at a position of a half of a height direction size thereof.

A lower-end portion of the tank 14 is connected to a water discharger 100. The water discharger 100 includes a water discharge rate regulator 24 coupled to the lower-end of the tank 14 and a water discharge pipe 25 coupled to the water discharge rate regulator 24.

The water discharge rate regulator 24 may be a regulator that allows a cook to directly regulate a water discharge rate using a manual valve or the like. Alternatively, the water discharge rate regulator 24 may be a regulator that allows a cook to regulate a water discharge rate by operating a control device for controlling the amounts of water supplied and discharged such that a liquid level of an upper surface of the water layer 11 or the oil layer 10 is maintained constant.

Below the water discharge pipe 25 is disposed a receiving tray 26, on which a filter 27 is mounted. The filter 27 separates water and fried scum bit discharged from the water discharger 100.

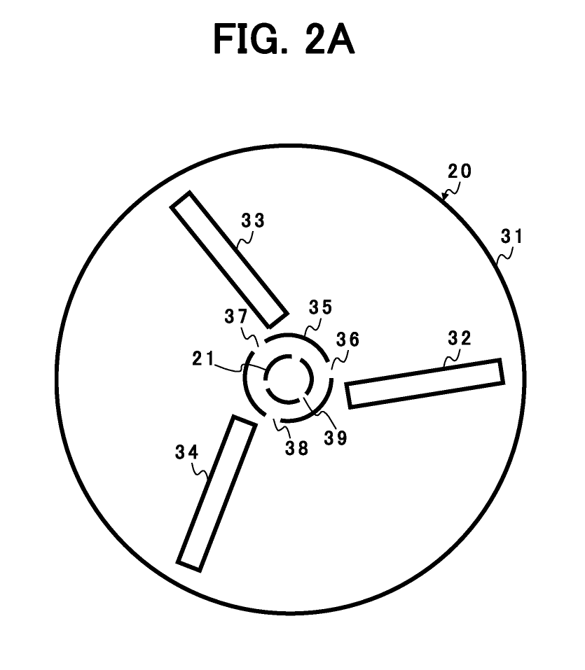

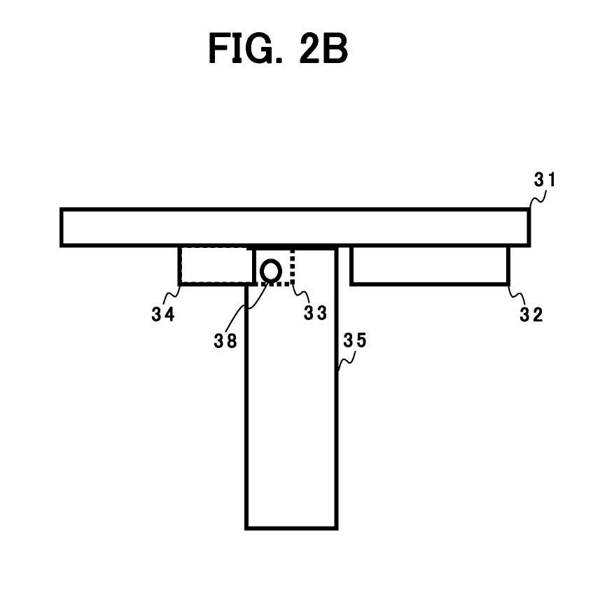

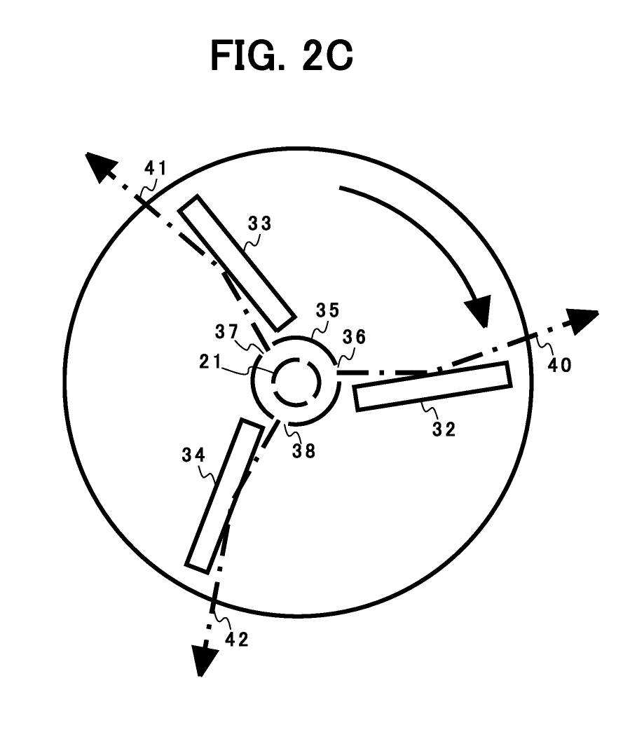

FIG. 2A is a schematic bottom view of the water supplier 20; FIG. 2B is a schematic front view of the water supplier 20; and FIG. 2C is an illustrative view of a rotation operation of the water supplier 20.

The water supplier 20 includes a circular plate 31 provided on an upper-end portion thereof. The circular plate 31 is positioned slightly lower than the upper surface of the water layer 11, as shown in FIG. 1. On a lower surface of the circular plate 31 are provided three blade plates 32 to 34. The respective blade plates 32 to 34 are substantially rectangular. Upper surfaces of the respective blade plates 32 to 34 are fixed to the lower surface of the circular plate 31. The three blade plates 32 to 34 are arranged so as to extend radially from a center of the circular plate 31 toward a peripheral portion thereof. Long sides of the respective blade plates 32 to 34 extend in a direction slightly inclined with respect to a straight line passing through the center of the circular plate 31. The inclination of the long sides of the blade plates 32 to 34 is provided to rotate the circular plate 31 by water striking against the blade plates 32 to 34. Of surfaces including the long sides of the respective blade plates 32 to 34, surfaces facing the center of the circular plate 31 (surfaces against which water strikes, as will be descried later) are inclined surfaces. The inclined surfaces are slightly inclined in a direction facing the lower-surface side of the circular plate 31 (an upward direction) (in a counter-clockwise direction in FIG. 2A). The inclination of the inclined surfaces of the respective blade plates 32 to 34 is provided to prevent the circular plate 31 from ascending due to water pressure from below.

An upper end of a rotating pipe 35 is fixed to a lower-surface center of the circular plate 31. The rotating pipe 35 is vertically extended. The rotating pipe 35 and the circular plate 31 have axes thereof on the same line. An upper-end portion of the water pipe 21 is inserted in the rotating pipe 35. The rotating pipe 35 is rotatable with respect to the water pipe 21.

At the upper-end portion of the rotating pipe 35 are formed three holes 36 to 38. The three holes 36 to 38 face centers of the inclined surfaces of the three blade plates 32 to 34. At the upper-end portion of the water pipe 21 are formed three holes 39. The three holes 39 are arranged at the same height as the height of the holes 36 to 38 formed on the rotating pipe 35.

One end of a discharge pipe 29 is connected to the tank 14. The one end of the discharge pipe 29 is positioned at a lower part of the oil layer 10. A cock 30 is connected to the other end of the discharge pipe 29.

Next, a description will be given of an operation of the variable waterflow-distribution fryer according to the first embodiment of the present invention.

A cook closes the water discharge rate regulator 24 and starts to operate the variable waterflow-distribution fryer in the closed state of the regulator. When the operation of the variable waterflow-distribution fryer is started, a predetermined flow rate of water is supplied into the water pipe 21 from a lower end thereof.

When the water is supplied into the water pipe 21, the water supplier 20 jets water from the upper end thereof radially in a horizontal direction, as will be described below. In the tank 14, the water layer 11 is formed by the water jetted from the water supplier 20. After forming the water layer 11 to an extent at which the water supplier 20 is submerged in the water, the cook opens the water discharge rate regulator 24. When the water discharge rate regulator 24 is opened, the water discharger 100 discharges the water of the water layer 11 outside the water discharger 100, whereby the upper surface of the water layer 11 is stably retained at a constant height. Next, the cook supplies cooking oil from an upper end opening 22 of the tank 14. When the cooking oil is supplied into the tank 14, a specific gravity difference between the water and the oil causes the oil layer 10 to be formed on the water layer 11.

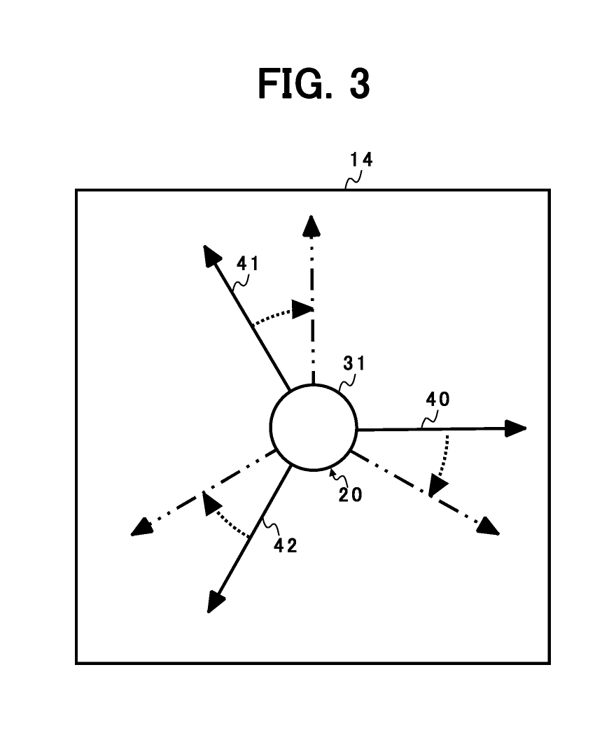

The water supplied into the water pipe 21 flows through the water pipe 21 from the lower end thereof to the upper end thereof. After having reached the upper end of the water pipe 21, the water passes through each hole 39 of the water pipe 21 and then passes through the holes 36 to 38 of the rotating pipe 35. The water after passing through the holes 36 to 38 of the rotating pipe 35 strikes against the inclined surfaces of the blade plates 32 to 34 to travel radially in a horizontal direction from the water supplier 20. In other words, the water supplier 20 jets the water radially in the horizontal direction. The water supplier 20 produces water jet flows (jet flows) 40 to 42 under an intermediate layer 12 by the radially jetted water, as shown in FIG. 3. In addition, the striking of the water after passing through the holes 36 to 38 against the inclined surfaces of the blade plates 32 to 34 causes the rotation of the circular plate 31, the blade plates 32 to 34, and the rotating pipe 35. Accordingly, as shown in FIG. 3, the directions of the water jet flows 40 to 42 change in accordance with the rotation of the circular plate 31, the blade plates 32 to 34, and the rotating pipe 35. The circular plate 31, the blade plates 32 to 34, and the rotating pipe 35 rotate at a rotation speed corresponding to a flow rate of the water supplied into the water supplier 20.

In addition, as described above, the inclined surfaces of the blade plates 32 to 34 are slightly inclined in the direction facing the lower-surface side of the circular plate 31 (the upward direction). Accordingly, due to the striking of the water jetted through the holes 36 to 38 against the inclined surfaces, a downward force is applied onto the blade plates 32 to 34, thereby preventing the circular plate 31 from ascending.

Water may be continuously supplied into the water pipe 21 or may be intermittently supplied into the water pipe 21, for example, in such a manner that water supply is stopped for 20 minutes after every 10 minutes of water supply.

The cook sets a surface temperature of the heater 23 to, for example, 170° C., when making food. A part of the oil layer 10 above the heater 23 is a high-temperature region in which convection occurs. A part of the oil layer 10 below the heater 23 is a low-temperature region in which convection hardly occurs. The lower part of the oil layer 10 has substantially the same temperature as that of the water layer 11.

When the cook fries food in the oil layer 10, an emulsifier contained in bread crumbs or the like adhered to the food flows out in the oil layer 10. The emulsifier after flowing out in the oil layer 10 forms the intermediate layer 12 containing an emulsion substance between the oil layer 10 and the water layer 11.

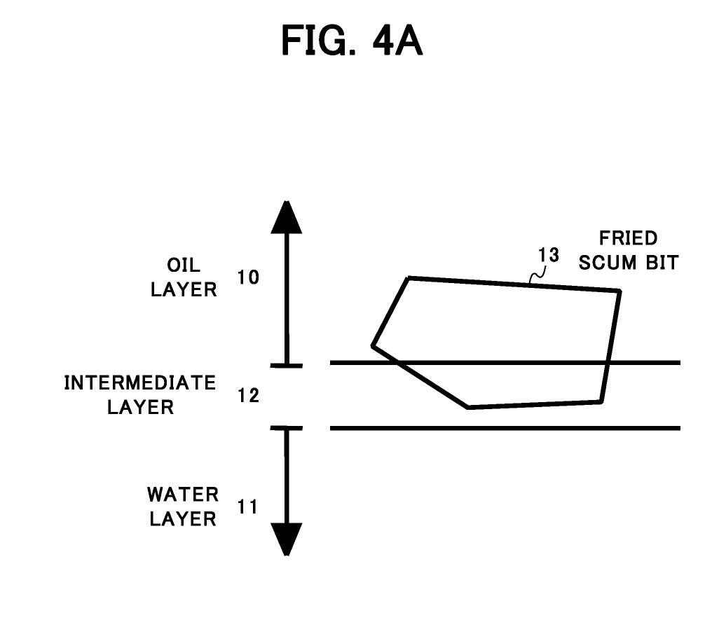

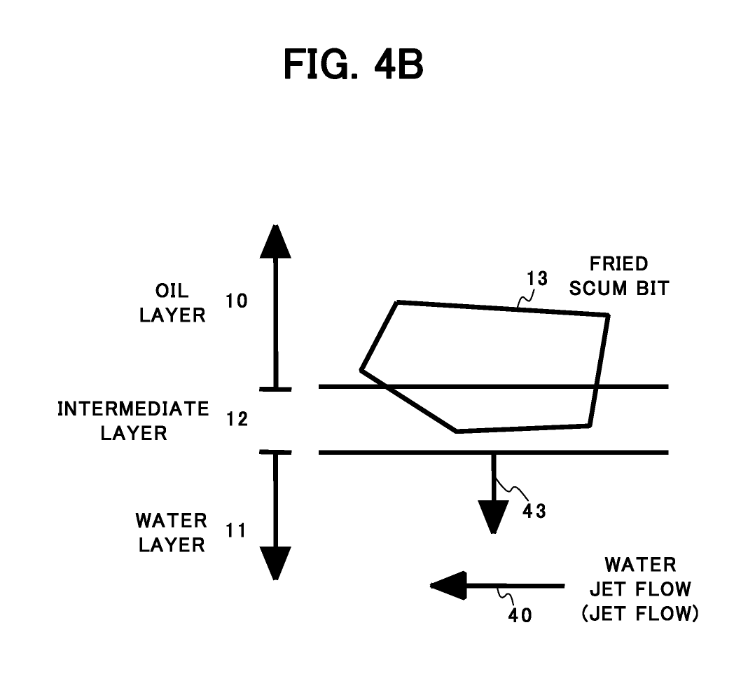

In addition, the frying of food in the oil layer 10 by the cook produces a fried scum bit 13 in the oil layer 10. The fried scum bit 13 sinks in the oil layer 10 due to a specific gravity difference from that of oil. Then, as shown in FIG. 4A, the fried scum bit 13 is caused to stagnate in the intermediate layer 12. The reason for the stagnation of the fried scum bit 13 in the intermediate layer 12 is, for example, that the intermediate layer 12 comprising a monomer, emulsion particles, or a micelle of a surfactant is pushed down by the fried scum bit 13 to enter the water layer 11, whereby the intermediate layer 12 is subjected to an upward force by the water of the water layer 11 to lift up the fried scum bit 13.

For example, in a state in which a monomer of surfactant is present in the intermediate layer 12, a hydrophilic group of the monomer is positioned in an upper side of the water layer 11 and a hydrophobic group of the monomer is positioned in a lower side of the intermediate layer 12. When the fried scum bit 13 pushes down the monomer in this state, the hydrophobic group of the monomer enters the water layer 11. The hydrophobic group is subjected to an upward force by the water of the water layer 11, as a result of which the fried scum bit 13 is lift up by the monomer.

In addition, for example, in a case in which W/O (water-in-oil) type emulsion particles of surfactant are present in the intermediate layer 12, pushing down of the emulsion particles by the fried scum bit 13 causes a hydrophobic group of the emulsion particles between the fried scum bit 13 and the upper surface of the water layer 11 to enter the water layer 11. The hydrophobic group is subjected to an upward force from the water of the water layer 11, whereby the fried scum bit 13 is lifted up by the emulsion particles. Alternatively, for example, even in a case in which a micelle of surfactant is present in the intermediate layer 12, results are the same as the case of the emulsion particles present in the intermediate layer 12.

When the emulsion particles or the micelle is present in a region other than the region between the fried scum bit 13 and the upper surface of the water layer 11, for example on a side surface of the fried scum bit 13, the emulsion particles or the like present on the side surface thereof do not lift up the fried scum bit 13. The upward force applied to the fried scum bit 13 from the intermediate layer 12 is not dependent on a thickness of the intermediate layer 12.

As shown in FIGS. 2C and 3, when the water supplier 20 jets water radially, water jet flows 40 to 42 are produced under the intermediate layer 12. As shown in FIG. 4B, when the water jet flow 40 is produced below the fried scum bit 13, pressure at a position of the water jet flow 40 produced is lowered, whereby a downward suction force 43 is applied to the intermediate layer 12 as shown in the drawing. The suction force 43 applied to the intermediate layer 12 causes the intermediate layer 12 to be deformed into a concave shape and causes the fried scum bit 13 to be pulled downward. When the lower part of the fried scum bit 13 enters the water layer 11, water enters voids of the fried scum bit 13. As a result, the entire weight of the fried scum bit 13 increases and the fried scum bit 13 sinks into the water layer 11.

In a case in which the water jet flow 40 occurs at a constant position, the position of the suction force 43 applied to the intermediate layer 12 does not change. Unless the position of the suction force 43 applied to the intermediate layer 12 changes, the shape of the intermediate layer 12 does not change and remains deformed after being deformed into the concave shape. The fried scum bit 13, which stagnates in the intermediate layer 12 whose shape does not change, does not sink into the water layer 11.

The directions of the water jet flows 40 to 42 change in accordance with the rotation of the circular plate 31 and the like, whereby positions without the water jet flows 40 to 42 occur under the intermediate layer 12. In the positions where the water jet flows 40 to 42 are not present, reduced pressure turns back to original level, as a result of which the suction force 43 is not applied to the intermediate layer 12. Due to no suction force 43 applied thereto, the concave portion of the intermediate layer 12 is lifted up by buoyancy, causing the intermediate layer 12 to be deformed into a convex shape. Next, the convex portion of the intermediate layer 12 is pulled downward by gravity, whereby the intermediate layer 12 then is deformed into a concave shape. In this manner, the intermediate layer 12 is repeatedly deformed as above and oscillates vertically. The oscillation of the intermediate layer 12 increases due to resonance when each of the water jet flows 40 to 42 is produced at a position corresponding to the convex portion of the intermediate layer 12 by adjusting the rotational speed of the circular plate 31 and the like.

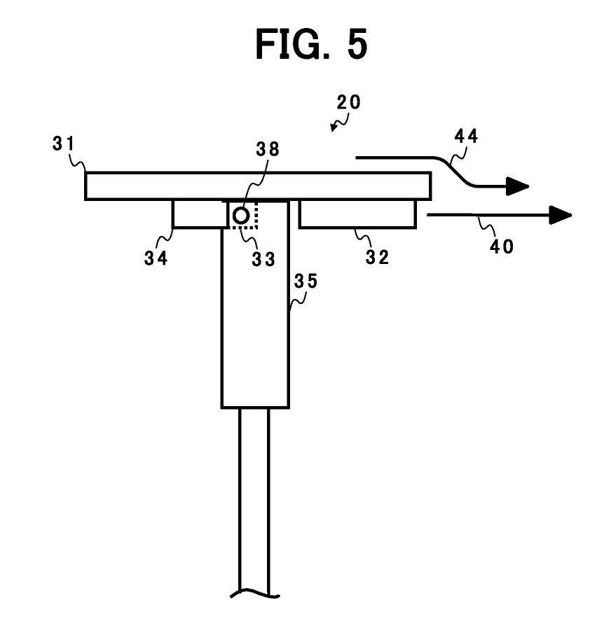

As described above, the directions of the water jet flows 40 to 42 change in accordance with the rotation of the circular plate 31 and the like, whereby the intermediate layer 12 oscillates vertically, greatly promoting the sinking of the fried scum bit 13. On a side above the circular plate 31, a water flow 44 as shown by an arrow of FIG. 5 is produced along with the water jet flows 40 to 42. The water flow 44 causes a portion of the intermediate layer 12 positioned on the side above the circular plate 31 to oscillate vertically.

The fried scum bit 13 having sunk into the water layer 11, together with water, passes through the water discharger 100 to be discharged therefrom. The water discharged from the water discharger 100 passes through the filter 27 and then is discharged below the receiving tray 26. Fried scum bit 28 discharged from the water discharger 100 are deposited on the filter 27.

After finishing cooking, the cook opens the cock 30. The oil of the oil layer 10 passes through the discharge pipe 29 and the cock 30 and is discharged outside the tank 14. After that, the cook fully opens the water discharge rate regulator 24, and the water of the water layer 11 passes through the water discharge pipe 25 to be discharged outside the tank 14. Then, the tank 14 becomes empty with no water and oil thereinside. As a result, the cook can clean up the inside of the tank 14.

The variable waterflow-distribution fryer according to the first embodiment of the present invention can efficiently cause the sinking of the fried scum bit 13 stagnating in the intermediate layer 12. In this manner, the variable waterflow-distribution fryer can reduce oil deterioration in the oil layer 10. In addition, the variable waterflow-distribution fryer can disperse not only the fried scum bit 13 but also impurities such as oil oxides and malodorous substances in the oil layer 10 in the water layer 11 by the oscillation of the intermediate layer 12. It is thus unnecessary to employ a complicated structure for cleaning the oil by allowing the oil in the oil layer 10 to flow into the water layer 11 through a pipe and a pump. Therefore, the variable waterflow-distribution fryer can achieve structural simplification and also can facilitate maintenance.

### Second Embodiment

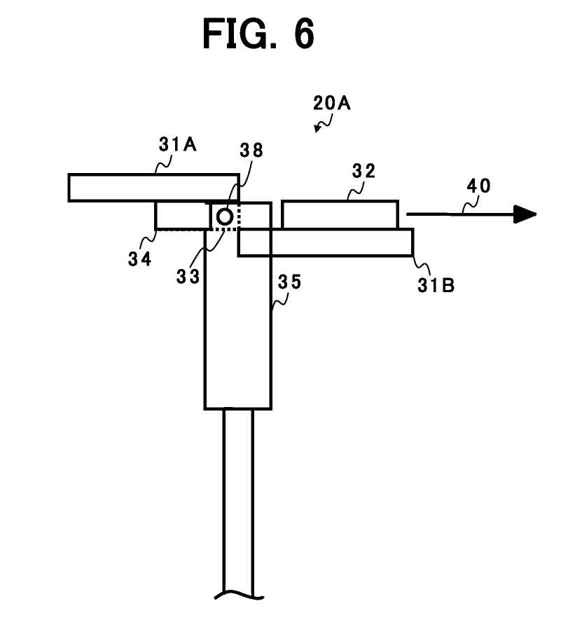

FIG. 6 is a schematic front view of a water supplier 20A of a variable waterflow-distribution fryer according to a second embodiment of the present invention.

The water supplier 20A includes a semi-circular plate 31A and a semi-circular plate 31B instead of the circular plate 31 shown in FIGS. 2A to 2C. The semi-circular plates 31A and 31B have a shape formed by splitting the circular plate 31 into halves. The semi-circular plate 31A is fixed to the upper end of the rotating pipe 35. The semi-circular plate 31A is positioned at the same height as that of the circular plate 31 of FIGS. 2A to 2C. In addition, the semi-circular plate 31B is fixed to the rotating pipe 35 at a position lower than a hole 38. The two blade plates 33 and 34 are fixed to a lower surface of the semi-circular plate 31A. The blade plate 32 is fixed to an upper surface of the semi-circular plate 31B. The arrangement of the respective blade plates 32 to 34 is the same as the arrangement of the respective blade plates 32 to 34 shown in FIG. 2A. An inclined surface of the blade plate 32 fixed to the semi-circular plate 31B (a surface facing the rotating pipe 35) is an inclined surface slightly inclined in a direction facing the intermediate layer 12 (an upward direction). The surface of the blade plate 32 facing the rotating pipe 35 may be a vertical surface.

Structures of other parts of the variable waterflow-distribution fryer according to the present second embodiment are the same as those of the variable waterflow-distribution fryer according to the first embodiment described above.

In the variable waterflow-distribution fryer according to the present second embodiment, a portion of the intermediate layer 12 positioned on a side above the water supplier 20A can be efficiently caused to oscillate vertically. Therefore, the fryer can efficiently cause the sinking of the fried scum bit 13 stagnating in the intermediate layer 12.

### Third Embodiment

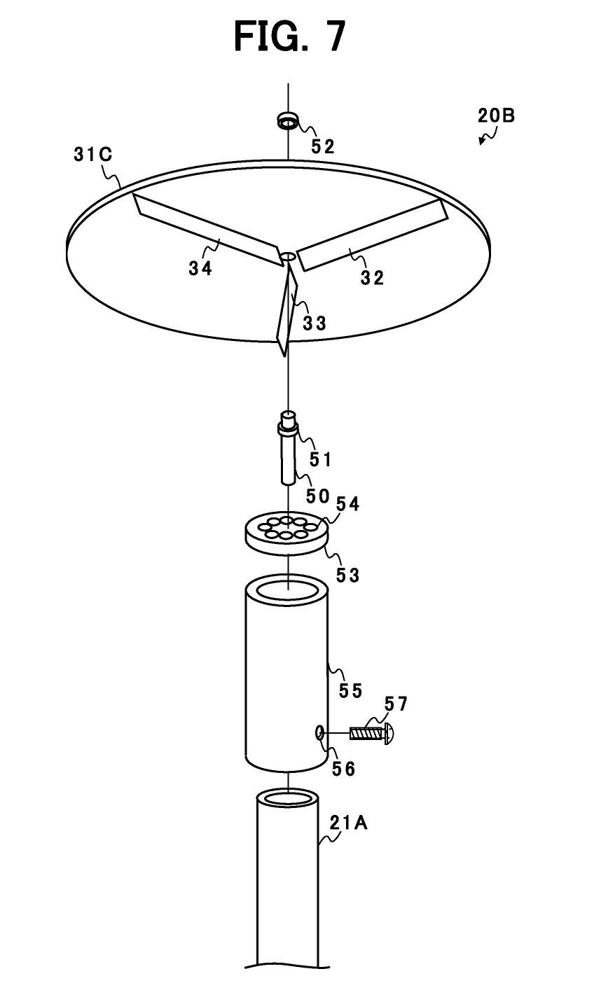

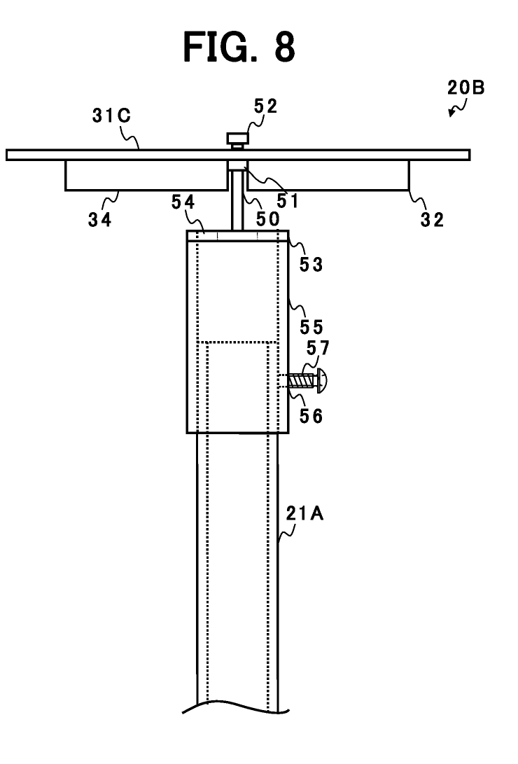

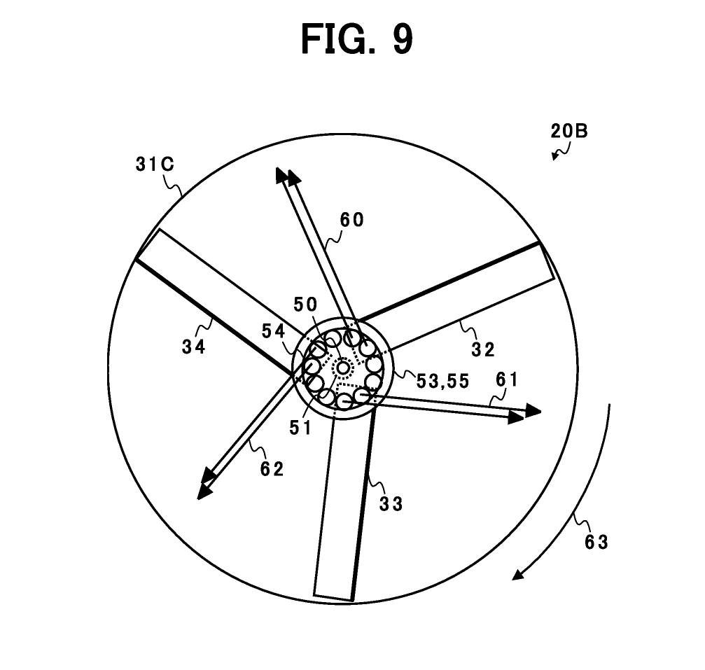

FIG. 7 is a schematic exploded perspective view of a water supplier 20B of a variable waterflow-distribution fryer according to a third embodiment of the present invention. FIG. 8 is a schematic front view of an assembly of the water supplier 20B shown in FIG. 7. FIG. 9 is a bottom view for illustrating an operation of the water supplier 20B shown in FIG. 8.

The water supplier 20B includes a circular plate 31C provided on an upper-end portion thereof. On the circular plate 31C are arranged three blade plates 32 to 34, as in the first embodiment above. Each of the blade plates 32 to 34 is fixed to the circular plate 31C in such a state that one surface thereof is inclined by substantially 45 degrees with respect to a vertical surface passing through the center portion of the circular plate 31C.

A hole is formed at the center portion of the circular plate 31C. A tip portion of a vertically extending spindle 50 is inserted into the hole. A stopper 51 and a stopper 52 are attached to the spindle 50 with the circulate plate 31C therebetween. The stoppers 51 and 52 restrict upward and downward movements of the circular plate 31C. The circular plate 31C is rotatable around the spindle 50.

An upper-surface center portion of a water-branching circular plate 53 is fixed to a lower end of the spindle 50. On the water-branching circular plate 53 are formed a plurality of circular holes 54 at an equal interval, which are centered around the position of a predetermined radius from the center of the plate 53. An upper end of a vertically extending height adjustment pipe 55 is fixed to a lower surface of the water-branching circular plate 53. The height adjustment pipe 55 has a screw hole 56 formed on a circumferential surface thereof. An upper-end portion of a water pipe 21A is inserted in the height adjustment pipe 55. A screw 57 is screwed in the screw hole 56 formed on the height adjustment pipe 55. The height adjustment pipe 55 is fixed to the water pipe 21A with the screw 57.

Next, a description will be given of an operation of the variable waterflow-distribution fryer according to the third embodiment of the present invention.

Water supplied into the water pipe 21A flows through the water pipe 21A from the lower end thereof to the upper end thereof. The water having reached the upper end of the water pipe 21A passes through the height adjustment tube 55 and is jetted from the plurality of circular holes 54 formed on the water-branching circular plate 53. The water jetted from the circular holes 54 strikes against the blade plates 32 to 34 and the bottom surface of the circular plate 31C. The water having struck against the blade plates 32 to 34 is bent by 90 degrees and travels in directions indicated by thick lines in FIG. 9 (directions perpendicular to base end lines of the blade plates) to become water jet flows 60 to 62. On the other hand, the water having struck against the bottom surface of the circular plate 31C is reflected downward. The water striking against the blade plates 32 to 34 is approximately a half of the water supplied by the water pipe 21.

When the water having struck against the blade plates 32 to 34 is bent by 90 degrees, a rotational force is applied to the circular plate 31C, thereby rotating the circular plate 31C and the blade plates 32 to 34 in a direction indicated by an arrow 63 of FIG. 9. The directions of the water jet flows 60 to 62 change in accordance with the rotation of the circular plate 31C and the like.

In the variable waterflow-distribution fryer according to the third embodiment, the intermediate layer 12 oscillates vertically as described in the first embodiment. In this manner, the variable waterflow-distribution fryer can efficiently cause the sinking of the fried scum bit 13 stagnating in the intermediate layer 12.

Next, a description will be given of conditions and results of an experiment performed using the variable waterflow-distribution fryer according to the third embodiment.

The conditions of the experiment are as follows. The tank 14 had an upper cross-section with a size of 400 mm×400 mm. The oil layer 10 had a thickness of 80 mm. The heater 23 had a surface temperature of 170° C. The water layer 11 had a water temperature of 10° C. The distance from the center position of the heater 23 up to the upper surface of the oil layer 10 was 40 mm. The circular plate 31C had a diameter of 100 mm. A distance “d” between the lower surface of the intermediate layer 12 and a center of the water jet flow 60 was 25 mm. The water pipe 21 had an inner diameter of 6 mm. The amount of water supplied into the water pipe 21 and the amount of water discharged by the water discharge rate regulator 24 was the liters/min of water layer 11.

The rotational speed of the circular plate 31C was approximately 8 seconds/rotation. The circular plate 31C smoothly rotated at a constant speed. The water jet flows 60 to 62 produced under the intermediate layer 12 had a cycle of approximately 8/3 (=2.7 seconds). The intermediate layer 12 had a vertical oscillation amplitude of approximately 15 mm at maximum. The intermediate layer 12 had a vertical oscillation cycle of 2 to 3 seconds. The oscillation cycle was substantially the same as the cycle of the water jet flows 60 to 62. Herein, a handful of bread crumbs were put in the oil layer 10 from the opening 22, and after 10 minutes, an investigation was made on the amount of fried scum bit 28 deposited on the filter 27, the amount of fried scum bit 13 stagnating in the intermediate layer 12, and the amount of fried scum bit deposited on inclined surfaces of the lower part of the tank 14.

The results of the experiment are as follows: the amount of the fried scum bit 28 deposited on the filter 27 was an amount of from approximately 90 to 95% of the total fried scum bit; the amount of the fried scum bit 13 stagnating in the intermediate layer 12 was almost zero; and the amount of the fried scum bit deposited on the inclined surfaces of the lower part of the tank 14 was an amount of from approximately 10 to 5% of the total fried scum bit.

While the intermediate layer 12 oscillated vertically, the upper surface of the oil layer 10 did not oscillate vertically. The oil in the low-temperature region of the oil layer 10 has a greater viscosity than the viscosity of the surfactant of the intermediate layer 12. Thus, vertical oscillation seems to be reduced in the low-temperature region of the oil layer 10. The distribution of temperature in the high-temperature region of the oil layer 10 was not different between when the intermediate layer 12 was oscillating vertically and when not oscillating vertically. In other words, the vertical oscillation of the intermediate layer 12 hardly influenced on a convection occurring in the high-temperature region of the oil layer 10.

Next, in order to compare a case of changing the directions of the water jet flows 60 to 62 with a case of not changing the directions thereof, an experiment was performed by locking the rotation of the circular plate 31C and setting the other conditions to be the same as those above.

The results of the experiment are as follows: the amount of the fried scum bit 28 deposited on the filter 27 was an amount of from approximately 40 to 70% of the total fried scum bit; and the amount of the fried scum bit 13 stagnating in the intermediate layer 12 was an amount of from approximately 60 to 30% of the total fried scum bit.

In this experiment, the effect of promoting the sinking of the fried scum bit seems to have resulted from that the water jet flows 60 to 62 and the water discharged from the lower part of the tank 14 produced a downward flow near the inner wall of the tank, resulting in the reduction of surfactant molecules present in the intermediate layer 12.

In the variable waterflow-distribution fryer according to the first embodiment, the circular plate 31 is rotated by striking most of the water supplied by the water pipe 21 against the blade plates 32 to 34. In contrast, in the variable waterflow-distribution fryer according to the third embodiment, the circular plate 31C is rotated by striking about a half of the water supplied by the water pipe 21A against the blade plates 32 to 34. Accordingly, the variable waterflow-distribution fryer according to the first embodiment can obtain the same effect as that of the variable waterflow-distribution fryer according to the third embodiment, even when the amount of water supplied into the water pipe 21 is set to approximately a half of the water supplied into the water pipe 21A of the variable waterflow-distribution fryer according to the third embodiment.

### Fourth Embodiment

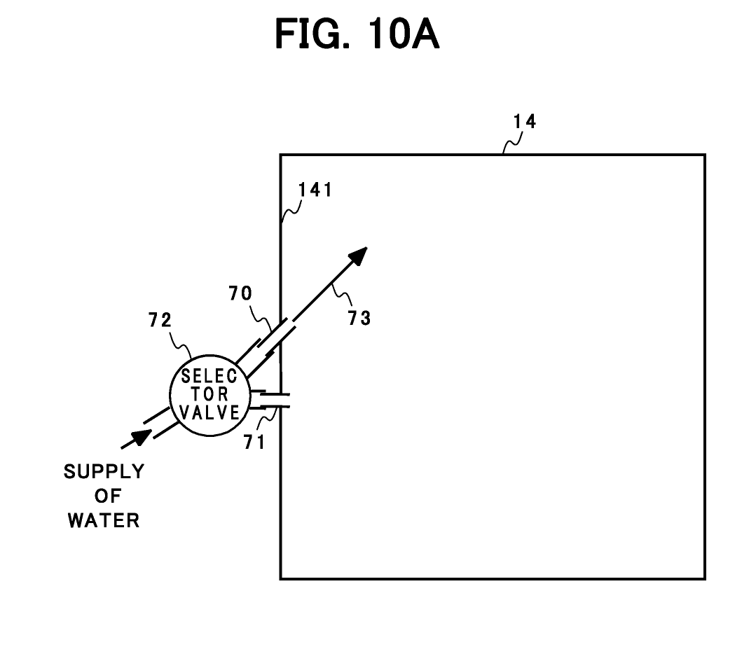

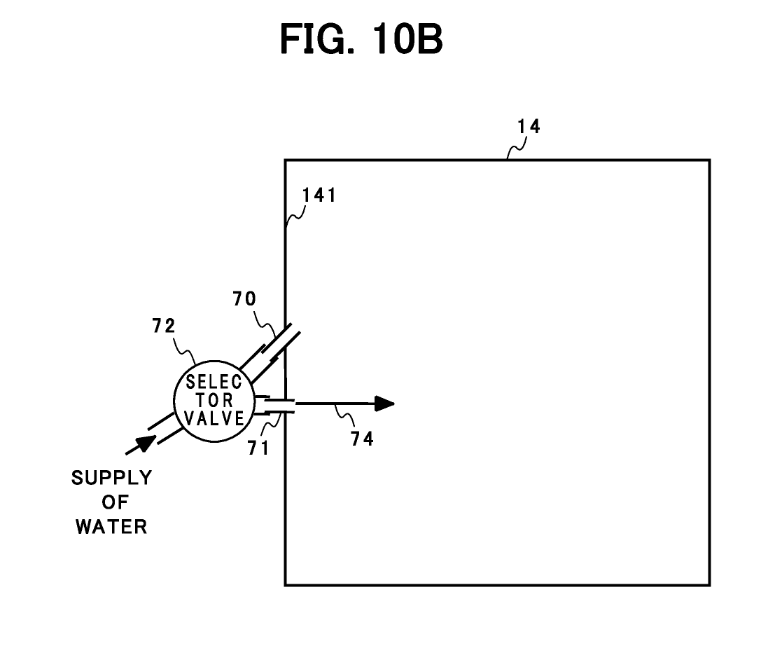

FIGS. 10A and 10B are schematic illustrative views of a water supplier of a variable waterflow-distribution fryer according to a fourth embodiment of the present invention.

As shown in FIG. 10A, two horizontally extending water supply nozzles 70 and 71 are attached to a wall surface 141 of the tank 14. The water supply nozzles 70 and 71 are positioned slightly lower than the upper surface of the water layer 11 shown in FIG. 1. Tip portions of the water supply nozzles 70 and 71 penetrate through the wall surface 141. At a base end portion of each of the water supply nozzles 70 and 71 is provided a selector valve 72. The selector valve 72 alternately supplies water supplied from the water pipe to the water supply nozzles 70 and 71, whereby the water supply nozzles 70 and 71 alternately jet water horizontally. The water supply nozzle 70 produces a water jet flow 73 by the horizontally-jetted water, as shown in FIG. 10A, and the water supply nozzle 71 produces a water jet flow 74 by the horizontally jetted water, as shown in FIG. 10B.

Axial directions of the water supply nozzles 70 and 71 are set such that a swirling flow occurs in the water layer 11. The flow rate of water jetted from the water supply nozzles 70 and 71 is set to a flow rate of an extent at which the swirling flow produced in the water layer 11 is transmitted to the intermediate layer 12 due to water viscosity to move the fried scum bit 13 stagnating in the intermediate layer 12 on the intermediate layer 12. In this manner, the variable waterflow-distribution fryer according to the fourth embodiment can obtain the same effect as that of the variable waterflow-distribution fryer according to the first embodiment.

### Fifth Embodiment

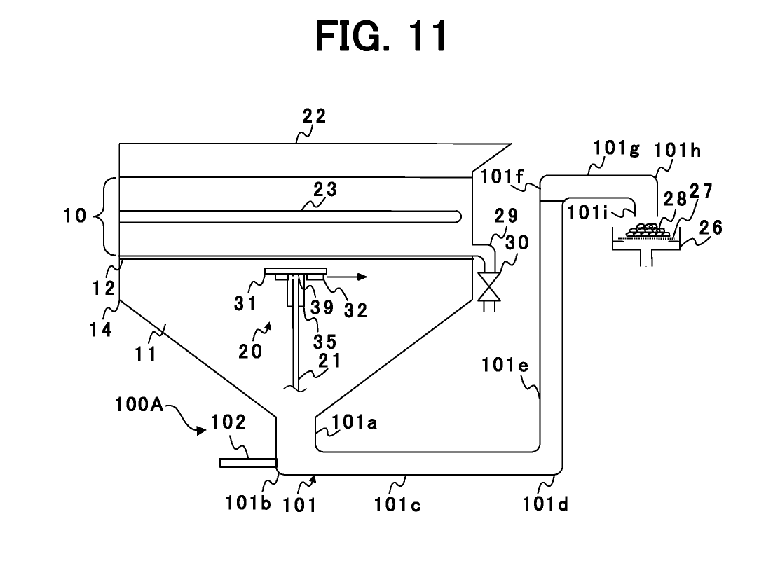

FIG. 11 is a schematic longitudinal sectional view of a water discharger of a variable waterflow-distribution fryer according to a fifth embodiment of the present invention.

As shown in FIG. 11, a water discharger 100A includes a water discharge pipe 101 and a water jet nozzle 102 as a water discharge accelerator.

The water discharge pipe 101 includes vertical portions 101a, 101e, and 101i each comprising a round pipe with an inner diameter of 40 mm, curved portions 101b, 101d, 101f, and 101h for changing a water flow direction by 90 degrees, and horizontal portions 101c and 101g each comprising a round pipe with an inner diameter of 40 mm. The water discharge pipe 101 is formed by sequentially coupling the vertical portion 101a, the curved portion 101b, the horizontal portion 101c, the curved portion 101d, the vertical portion 101e, the curved portion 101f, the horizontal portion 101g, the curved portion 101h, and the vertical portion 101i. An upper end of the vertical portion 101a is connected to the lower part of the tank 14. The horizontal portion 101g is positioned slightly lower than the upper surface of the oil layer 10.

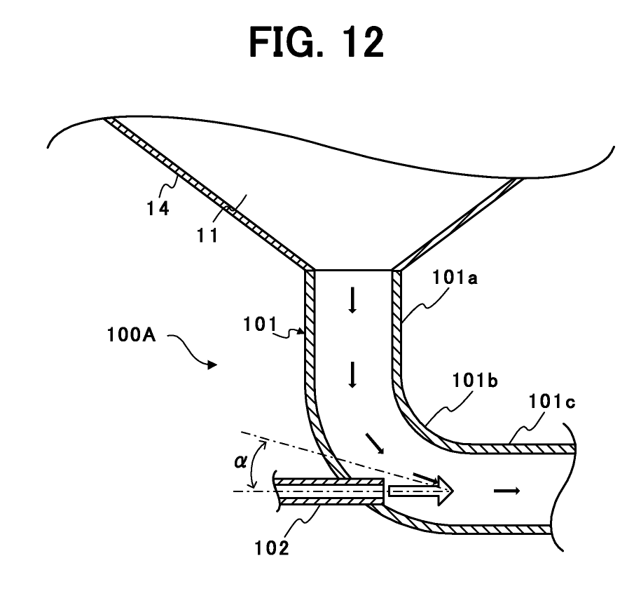

The water jet nozzle 102 comprises, as one example, a round pipe having a tip opening with a diameter of 10 mm. As shown in FIG. 12, the water jet nozzle 102 is provided at the curved portion 101b. The water jet nozzle 102 penetrates through the curved portion 101b. The tip portion of the water jet nozzle 102 that is protruding inside the water discharge pipe 101 is very small. A jet outlet (the tip opening) of the water jet nozzle 102 faces the horizontal portion 101c. An angle “a” formed by a direction in which the water jet nozzle 102 jets water and a direction in which water flows in the curved portion 101b is less than 90 degrees.

Even the variable waterflow-distribution fryer according to the fifth embodiment also includes the water supplier 20, the water pipe 21, the receiving tray 26, the filter 27, and the like described in the first to the third embodiments.

Next, a description will be given of an operation of the variable waterflow-distribution fryer according to the fifth embodiment, with reference to FIGS. 11 to 13.

As shown in FIG. 11, in a state in which oil and water are in the tank 14, a force of the oil of the oil layer 10 and the water of the water layer 11 pushing water in the water discharge pipe 101 is balanced with a force of the water in the water discharge pipe 101 pushing the oil of the oil layer 10 and the water of the water layer 11. In addition, an upper surface of the water in the water discharge pipe 101 is positioned slightly lower than the horizontal portion 101g of the water discharge pipe 101.

In this state, when water is supplied through the water pipe 21, the water supplier 20 jets the water from the upper-end portion thereof radially in the horizontal direction, as described in the first embodiment. The flow rate of the water supplied into the water layer 11 from the water supplier 20 is set to, as one example, 7 liters per minute (7 liters/min). The water in the water layer 11 flows into the water discharge pipe 101, as shown by black arrows in FIG. 12, and passes through the vertical portion 101a and the curved portion 101b.

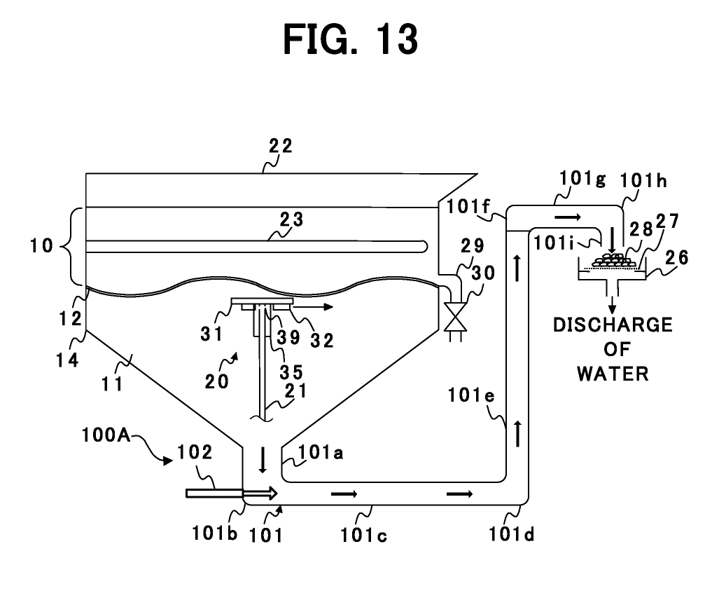

In addition, at the curved portion 101b, the water jet nozzle 102 jets water in a direction indicated by a white arrow in FIG. 12. The flow rate of the water jetted from the water jet nozzle 102 is set to, as one example, 4 liters per minute (4 liters/min). The flow rates of the water mentioned above are changed as needed depending on the sizes of the water layer 11 and the water discharge pipe 101 and the like. The angle “a” formed by the direction in which the water jet nozzle 102 jets water and the direction in which the water flows in the curved portion 101b is less than 90 degrees, as described above. Thus, the water jet nozzle 102 accelerates the water in the water discharge pipe 101 in a direction indicated by black arrows in FIG. 13 (a direction in which the water flows) by the jetted water. The water jetted from the water jet nozzle 102, together with the water in the water discharge pipe 101, passes through the horizontal portion 101c, the curved portion 101d, the vertical portion 101e, the curved portion 101f, the horizontal portion 101g, the curved portion 101h, and the vertical portion 101i of the water discharge pipe 101, as indicated by the black arrows in FIG. 13, to be discharged onto the receiving tray 26. The flow rate of the water discharged from the water discharge pipe 101 is a flow rate obtained by summing the flow rate of water supplied into the water layer 11 from the water supplier 20 and the flow rate of water jetted from the water jet nozzle 102, namely, 11 liters per minute (11 liters/min).

The water jet nozzle 102 is provided at the curved portion 101b, as described above. Accordingly, water flowing through the water discharge pipe 101 is efficiently accelerated at the curved portion 101b.

In this manner, the water jetted from the water jet nozzle 102 accelerates the water flowing through the water discharge pipe 101, thus increasing the flow rate of the water in the water discharge pipe 101. As a result, in the variable waterflow-distribution fryer, the flow rate of water supplied into the water layer 11 from the water supplier 20 can be set to be large. In other words, when the water in the water discharge pipe 101 is not accelerated, the flow rate of the water in the water discharge pipe 101 is a natural flow rate (less than 7 liters per minute) based on the weight of water supplied from the water supplier 20 even if at maximum level. In contrast, the acceleration of water in the water discharge pipe 101 increases the flow rate of the water in the water discharge pipe 101. Thus, in the variable waterflow-distribution fryer, the flow rate of water supplied into the water layer 11 from the water supplier 20 can be set to be larger than the natural flow rate.

In the variable waterflow-distribution fryer, the entire part of the intermediate layer 12 formed in the tank 14 oscillates vertically by setting the flow rate of water supplied into the water layer 11 from the water supplier 20 to be large as described above, thus efficiently causing the sinking of the fried scum bit 13 into the water layer 11 from the intermediate layer 12.

In addition, setting the flow rate of water supplied into the water layer 11 from the water supplier 20 to be large in the variable waterflow-distribution fryer as described above increases a force of water flowing into the water discharge pipe 101 from the water layer 11. As a result, even when the fried scum bit 13 has sunk down onto the inclined surfaces of the lower part of the tank 14, the fried scum bit 13 is caught by the force of the water to be sucked into the water discharge pipe 101. Thus, the fried scum bit 13 hardly remains on the inclined surfaces of the lower part of the tank 14.

The fried scum bit 13 sucked in the water discharge pipe 101 passes through the curved portion 101b. The tip portion of the water jet nozzle 102 protruding inside the water discharge pipe 101 is very small, as described above. Accordingly, the tip portion of the water jet nozzle 102 does not interfere with the fried scum bit 13 flowing through the water discharge pipe 101.

As described hereinabove, in the variable waterflow-distribution fryer according to the fifth embodiment, the water jet nozzle 102 accelerates water flowing through the water discharge pipe 101, so that the flow rate of water supplied into the water layer 11 from the water supplier 20 can be set to be large in the variable waterflow-distribution fryer.

Accordingly, the variable waterflow-distribution fryer allows the entire part of the intermediate layer 12 formed in the tank 14 to oscillate vertically, thereby efficiently causing the sinking of the fried scum bit 13 from the intermediate layer 12.

In the variable waterflow-distribution fryer according to the fifth embodiment, the water discharge accelerator comprises the water jet nozzle 102. Accordingly, the variable waterflow-distribution fryer can accelerate water flowing through the water discharge pipe 101 by the simple structure.

In the variable waterflow-distribution fryer according to the fifth embodiment, the water jet nozzle 102 is provided at the curved portion 101b of the water discharge pipe 101. Accordingly, the variable waterflow-distribution fryer can efficiently accelerate water at the curved portion 101b.

In the variable waterflow-distribution fryer according to the fifth embodiment, the tip portion of the water jet nozzle 102 does not interfere with the fried scum bit 13 flowing through the water discharge pipe 101. Accordingly, the variable waterflow-distribution fryer can prevent the reduction of the flow rate of water in the water discharge pipe 101 due to clogging of the fried scum bit 13.

While some preferable embodiments of the present invention have been described hereinabove, the invention includes other various modifications, such as other combinations of the elements described in the plurality of embodiments above, modifications using other structures achieving the functions of the respective elements, and other structures that would be conceivable to those skilled in the art, from the structures or functions of the elements.

It is enough for the present invention to include the structure that allows the water supplier to substantially horizontally jet water in the water layer and change the directions of the jetting of the water. In the first to the third embodiments and the fifth embodiment, water is jetted in the three directions from the upper-end portion of the water supplier 20, 20A, or 20B, as shown in FIGS. 2C, 6, and 9. However, the direction of the water jetted from the water supplier is not limited to the three directions, and, for example, may be two or fewer directions or four or more directions.

In the first to the third embodiments and the fifth embodiment, the circular plate 31, the semi-circular plate 31A, the semi-circular plate 31B, and the circular plate 31C rotate to change the directions of the water jet flows 40 to 42 or 60 to 62. However, the directions of the water jet flows 40 to 42 or 60 to 62 may be changed without rotating the circular plate 31, the semi-circular plates 31A and 31B, and the circular plate 31C. For example, the directions of the water jet flows may be changed by switching portions for jetting water in the water supplier 20 to produce the water jet flows 40, 41, and 42 in turn.

In the first to the third embodiments and the fifth embodiment, it has been described that the intermediate layer 12 comprises a monomer, emulsion particles, or a micelle of a surfactant. However, the intermediate layer 12 is not limited to one comprising a monomer, emulsion particles, or a micelle thereof. In the present invention, even an intermediate layer 12 comprising a substance other than a monomer, emulsion particles, or a micelle can be used as long as the intermediate layer can oscillate vertically.

In the first to the third embodiments and the fifth embodiment, the water pipes 21 and 21A extend vertically. However, the water pipes 21 and 21A are not limited to those extending vertically. For example, the water pipes 21 and 21A may be of an L-letter shape. In this case, for example, one end of the water pipe 21 or 21A may be fixed to the inner wall of the tank 14.

In the fourth embodiment, as shown in FIGS. 10A and 10B, the two water supply nozzles 70 and 71 are provided on the wall surface 141 of the tank 14. However, the number of the water supply nozzles attached on the wall surface 141 of the tank 14 is not limited to two, and for example, may be one or three or more. Alternatively, on a wall surface other than the wall surface 141 of the tank 14 may be provided one or plurality of water supply nozzles.

The structure of any of the first to the third embodiments may be combined with the structure of the fourth embodiment. In addition, the structure of any of the first to the fourth embodiments may be combined with the structure of the fifth embodiment.

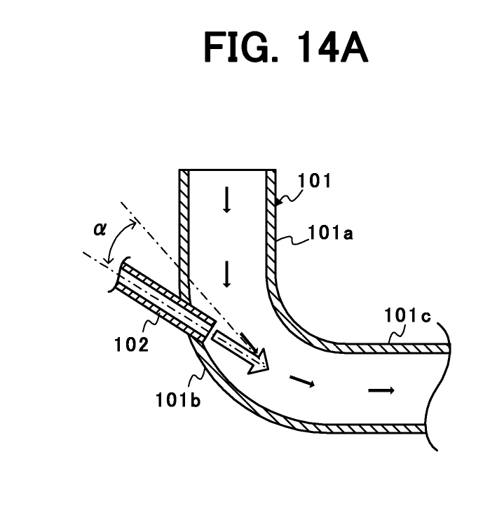

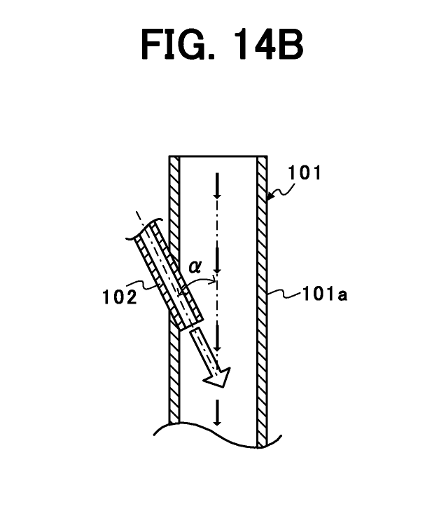

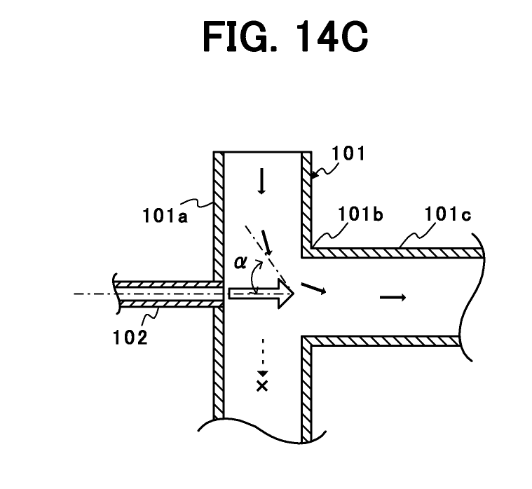

In the fifth embodiment, the jet outlet of the water jet nozzle 102 faces the horizontal portion 101c. However, the jet outlet thereof does not have to face the horizontal portion 101c. For example, as shown in FIG. 14A, the water jet nozzle 102 may be attached to the curved portion 101b in a slanting posture. The variable waterflow-distribution fryer having such a structure can efficiently accelerate water in the curved portion 101b.

In the fifth embodiment, the water jet nozzle 102 is provided at the curved portion 101b of the water discharge pipe 101. However, the water jet nozzle 102 does not have to be provided at the curved portion 101b thereof. For example, as shown in FIG. 14B, the water jet nozzle 102 may be provided at the vertical portion 101a of the water discharge pipe 101 in a slanting posture. The variable waterflow-distribution fryer having such a structure can accelerate water flowing through the water discharge pipe 101 by the water jet nozzle 102.

In the fifth embodiment, the water discharge pipe 101 is formed by sequentially coupling the vertical portion 101a, the curved portion 101b, the horizontal portion 101c, the curved portion 101d, the vertical portion 101e, the curved portion 101f, the horizontal portion 101g, the curved portion 101h, and the vertical portion 101i. However, the structure of the water discharge pipe 101 is not limited to the above structure. For example, as shown in FIG. 14C, the horizontal portion 101c may be coupled to a certain point along the length of the vertical portion 101a. In this case, for example, at a lower end of the vertical portion 101a may be provided a normally closed valve for forced discharge. In this structure, water flows from an upper part of the vertical portion 101a to the horizontal portion 101c but does not flow from the upper part of the vertical portion 101a to a lower part of the vertical portion 101a. In the water discharge pipe 101 having such a structure as above, a portion where the vertical portion 101a is coupled to the horizontal portion 101c becomes the curved portion 101b. In this case, for example, the water jet nozzle 102 is provided at the vertical portion 101a in a horizontal posture. Then, the jet outlet of the water jet nozzle 102 faces the horizontal portion 101c, and the tip surface of the water jet nozzle 102 is made flush with an inner surface of the vertical portion 101a. The variable waterflow-distribution fryer having such a structure can accelerate water flowing through the water discharge pipe 101 by the water jet nozzle 102. In addition, since the tip surface of the water jet nozzle 102 is made flush with the inner surface of the vertical portion 101a, the water jet nozzle 102 does not interfere with the fried scum bit 13 flowing through the water discharge pipe 101. Thus, the variable waterflow-distribution fryer having such a structure as above can prevent the reduction of the flow rate of water in the water discharge pipe 101 due to clogging of the fried scum bit 13.

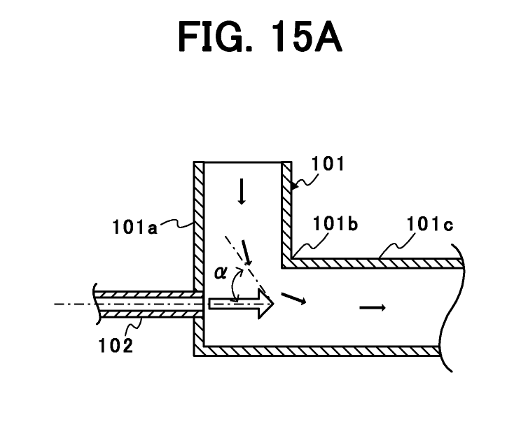

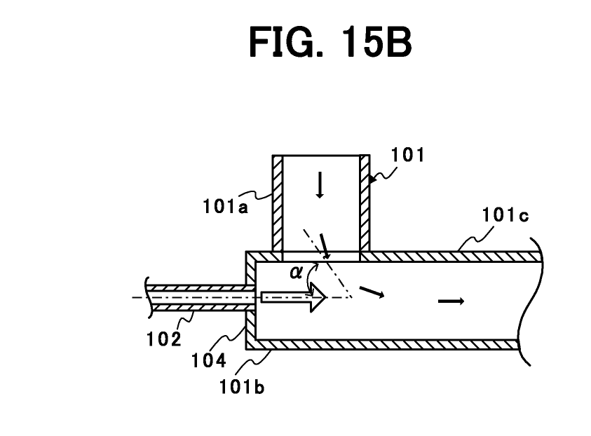

In addition, for example, the vertical portion 101a may be coupled to the horizontal portion 101c in such a manner as shown in FIG. 15A. In this case, for example, the water jet nozzle 102 is provided at the lower end of the vertical portion 101a in a horizontal posture. The jet outlet of the water jet nozzle 102 faces the horizontal portion 101c. The variable waterflow-distribution fryer having such a structure can accelerate water flowing through the water discharge pipe 101 by the water jet nozzle 102. The vertical portion 101a and the horizontal portion 101c shown in FIG. 15A comprise, as one example, a square pipe having an inner diameter (one side) of 40 mm. In this structure, as one example, the flow rate of water supplied into the water layer 11 from the water supplier 20 is set to 4 liters per minute (4 L/min), and the flow rate of water jetted from the water jet nozzle 102 is set to 5 liters per minute (5 liters/min). The variable waterflow-distribution fryer having such a structure can accelerate water flowing through the water discharge pipe 101 by the water jet nozzle 102.

In addition, for example, as shown in FIG. 15B, the vertical portion 101a may be coupled to a certain point along the length of the horizontal portion 101c. A closing plate 104 is attached to one end of the horizontal portion 101c. The water jet nozzle 102 is mounted to the closing plate 104. Even in this structure, the flow rate of water supplied into the water layer 11 from the water supplier 20 is set to 4 liters per minute (4 L/min). In addition, the flow rate of water jetted from the water jet nozzle 102 is set to 5 liters per minute (5 L/min). The vertical portion 101a shown in FIG. 15B comprises, as one example, a round pipe having an inner diameter of 40 mm. The horizontal portion 101c comprises, as one example, a square pipe having an inner diameter (one side) of 40 mm. The flow rates mentioned above are changed as needed depending on the sizes of the water layer 11 and the water discharge pipe 101 and the like. The variable waterflow-distribution fryer having such a structure can accelerate water flowing through the water discharge pipe 101 by the water jet nozzle 102.

Even in the structures shown in FIGS. 14A to 14C and FIGS. 15A and 15B, the angle “α” formed by the direction in which the jet nozzle 102 jets water and the direction in which water flows in the water discharge pipe 101 is less than 90 degrees.

In addition, for example, the water discharge pipe 101 may include an inclined portion extending in a direction other than the vertical and horizontal directions.

In the fifth embodiment, the water discharge accelerator comprises the water jet nozzle 102. However, the water discharge accelerator is not limited to the water jet nozzle 102, and, for example, may comprise a pump.

Besides, specific structural details and the like can also be changed as needed.

What is claimed is:

1. A variable waterflow-distribution fryer comprising:
a tank accommodating oil and water, in which a specific gravity difference between the oil and the water causes formation of an oil layer on top and a water layer on bottom;
a heater arranged in the oil layer;
a water supplier supplying water into the water layer; and
a water discharger discharging the water of the water layer from a lower part of the tank,
wherein, in the water layer under an intermediate layer formed between the oil layer and the water layer, the water supplier substantially horizontally jets water and changes the direction of the jetting of the water.

2. The variable waterflow-distribution fryer according to claim 1, wherein in the water layer, the water supplier jets water radially from a cross-sectional center portion of the tank and rotates a jet flow around the center portion of the tank.

3. The variable waterflow-distribution fryer according to claim 2, wherein the water supplier comprises:
a water pipe fixed to the tank to guide water from outside of the tank to inside of the tank and guide the water upward in a longitudinal-sectional center portion of the tank and the water layer; and
a rotary body including a circular plate, a plurality of blade plates radially fixed to one end surface of the circular plate from a center portion of the plate to a peripheral portion of the plate, a vertically extending rotating pipe fixed to the center portion of the circular plate, and holes provided on a peripheral surface of the rotating pipe, each of the holes facing each of the plurality of blade plates, in which the rotating pipe is fitted onto an upper portion of the water pipe, and water jetted through the holes of the rotating pipe from a plurality of holes of the water pipe is caused to strike against the plurality of blade plates to rotate the circular plate with respect to the water pipe,
the water supplier substantially horizontally jetting the water having struck against the plurality of blade plates.

4. The variable waterflow-distribution fryer according to claim 2, wherein the water supplier comprises:
a water pipe fixed to the tank to guide water from outside of the tank to inside of the tank and guide the water upward in a longitudinal-sectional center portion of the tank and the water layer;
a branching jet pipe connected to the water pipe to branch the water guided by the water pipe into a plurality of water flows and jet the water flows toward right above the jet pipe from an upper end surface of the jet pipe; and
a rotary body including a circular plate, a plurality of blade plates radially fixed to one end surface of the circular plate from a center portion of the plate to a peripheral portion of the plate, and a spindle supporting the circular plate that is horizontally arranged, rotatably around the center of the plate, a lower-end portion of the spindle that is vertically arranged being fixed onto a center portion of the upper end surface of the branching jet pipe, and wherein the water jetted from the branching jet pipe is caused to strike against the plurality of blade plates and reflected substantially horizontally to rotate the circular plate.

5. The variable waterflow-distribution fryer according to claim 1, wherein the water supplier intermittently jets water having a flow rate that allows a fried scum bit stagnating in the intermediate layer to move horizontally, from a wall surface of the tank into the water layer.

6. The variable waterflow-distribution fryer according to claim 5, wherein the water supplier cyclically repeats an operation of starting a jetting of water into the water layer from a plurality of portions of the wall surface of the tank in a predetermined order and stopping the jetting of the water in the predetermined order.

7. The variable waterflow-distribution fryer according to claim 1, wherein the water discharger comprises a water discharge pipe connected to the tank and a water discharge accelerator accelerating water in the water discharge pipe in a direction of flow of the water.

8. The variable waterflow-distribution fryer according to claim 7, wherein the water discharge accelerator comprises a water jet nozzle that jets water in the flow direction in order to accelerate the water flowing through the water discharge pipe.

9. The variable waterflow-distribution fryer according to claim 8, wherein the water discharge pipe comprises a curved portion that changes the direction of the flow of the water in the water discharge pipe, and the water jet nozzle is provided at the curved portion.

10. The variable waterflow-distribution fryer according to claim 8, wherein the water jet nozzle penetrates through the water discharge pipe and is provided in such a manner that a tip surface of the nozzle is made flush with an inner surface of the water discharge pipe.
